(19) United States
(12) Patent Application Publication
(10) Pub. No.: US 2024/0255886 A1
(43) Pub. Date: Aug. 1, 2024

(54) CHARGE-ELIMINATING DEVICE AND IMAGE FORMING SYSTEM

(71) Applicant: CANON KABUSHIKI KAISHA, Tokyo (JP)

(72) Inventors: YASUHARU CHIYODA, Chiba (JP); YUTAKA KAKEHI, Chiba (JP); RYOSUKE TSURUGA, Chiba (JP)

(21) Appl. No.: 18/425,811

(22) Filed: Jan. 29, 2024

(30) Foreign Application Priority Data
Jan. 30, 2023 (JP) 2023-011718

(51) Int. Cl. G03G 15/00; B65H 5/06

(52) U.S. Cl. CPC G03G 15/6573; B65H 5/064; B65H 2301/5133

(57) ABSTRACT

A charge-eliminating device for eliminating charge of a sheet on which toner is fixed by an image forming apparatus includes a conveying guide, a first charge-eliminating unit and a second charge-eliminating unit. The conveying guide forms a conveyance passage through which the sheet conveyed from the image forming apparatus is conveyed. The first charge-eliminating unit is disposed on one side of the conveyance passage in a thickness direction of the sheet and eliminates charge of the sheet in a non-contact state with the sheet. The second charge-eliminating unit is disposed on the other side of the conveyance passage in the thickness direction and eliminates charge of the sheet in the non-contact state with the sheet.

### FIELD OF THE INVENTION AND RELATED ART

The present invention relates to a charge-eliminating device for eliminating charge of a sheet recording material and an image forming system to which the charge-eliminating device is applied.

Conventionally, recording materials which are discharged from image forming apparatuses applying electrophotographic methods or electrostatic recording methods may be electrically charged, so charge-eliminating devices have been developed to remove the electric charges. As for a charge-eliminating device, a charge-eliminating device which includes a contact type charge-eliminating unit such as a charge-eliminating roller pair and a non-contact type charge-eliminating unit such as a corotron type has been developed (Japanese Laid-Open Patent Application (JP-A) 2019-167169). The corotron type charge-eliminating unit includes a wire electrode which is arranged on one side of the recording material and an earth electrode which is arranged on the other side, generates ions by corona discharging when a high voltage potential to the wire electrode is applied, and eliminates charge of the recording material.

However, in a case of the recording material in which electrical resistance is high such as synthetic paper, polarity on a front side of paper is opposite to polarity on a back side of it when it is electrically charged. Therefore, even when trying to eliminate charge by irradiating with ions on only one side of the recording material, charge on the other side of the recording material remains retained since an electric current does not flow, so charge-eliminating performance may be significantly deteriorated. Therefore, in a case of a configuration of the conventional charge-eliminating device, the charge-eliminating performance is not sufficient.

### SUMMARY OF THE INVENTION

An object of the present invention is to provide a charge-eliminating device and an image forming system capable of improving charge-eliminating performance.

According to an aspect of the present invention, there is provided a charge-eliminating device for eliminating charge of a sheet on which toner is fixed by an image forming apparatus, the charge-eliminating device comprising: a conveying guide configured to form a conveyance passage through which the sheet conveyed from the image forming apparatus is conveyed: a first charge-eliminating unit disposed on one side of the conveyance passage in a thickness direction of the sheet and configured to eliminate charge of the sheet in a non-contact state with the sheet; and a second charge-eliminating unit disposed on the other side of the conveyance passage in the thickness direction and configured to eliminate charge of the sheet in the non-contact state with the sheet.

Further features of the present invention will become apparent from the following description of exemplary embodiments with reference to the attached drawings.

### BRIEF DESCRIPTION OF THE DRAWINGS

FIG. 1 is a sectional view showing an image forming system according to an embodiment.

FIG. 2 is a sectional view showing a charge-eliminating device according to the embodiment.

FIG. 3 is a plan view showing a first guide member according to the embodiment.

FIG. 4 is a flowchart showing a procedure for charge-eliminating by the charge-eliminating device according to the embodiment.

FIG. 5 is a table showing evaluation results under various conditions.

FIG. 6 is an explanatory drawing which describes a principle of charge-eliminating and shows a case of irradiating with ions from a top surface only.

FIG. 7 is an explanatory drawing which describes a principle of charge-eliminating and shows a case of irradiating with ions from both sides.

### DESCRIPTION OF THE EMBODIMENTS

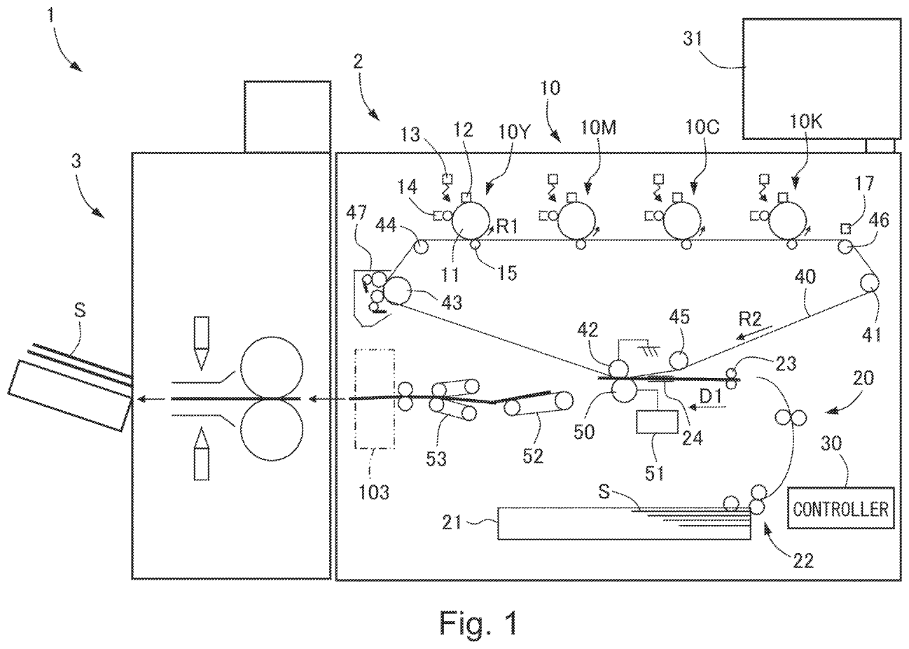

In the following, an embodiment of the present invention will be described with reference to Figures. First, a schematic configuration of an image forming system 1 according to the embodiment will be described by using FIG. 1. As shown in FIG. 1, the image forming system 1 is provided with an image forming apparatus 2 which forms an image on a recording material and a charge-eliminating device 3 which is connected on a downstream side of the image forming apparatus 2 as a separate device and eliminates charge from the recording material which is discharged from the image forming apparatus 2. Dimensions, materials and relative positions of component parts of the image forming apparatus 2 and the charge-eliminating device 3 are not intended to limit the scope of the disclosure to them alone, unless otherwise specifically stated.

### [Image Forming Apparatus]

FIG. 1 is a sectional view showing a schematic configuration of the image forming apparatus 2 according to the embodiment. Incidentally, a full color copier which is provided a plurality of photosensitive drums is applied as the image forming apparatus 2 in the embodiment. However, it is not limited to this and it is also possible to apply to monochrome and mono-color copiers and printers which are provided with a single photosensitive drum. Further, it is not limited to an electrophotographic method, however, it is also possible to apply to, for example, an image forming apparatus of an inkjet method.

The image forming apparatus 2 includes an image forming portion 10, a sheet conveying portion 20, a control portion 30 and an operation portion 31. The image forming portion 10 includes a station 10Y, a station 10M, a station 10C and a station 10K, and forms an image on a recording material which is conveyed by the sheet conveying portion 20. A sheet S as a recording material includes a paper such as a thin paper and a thick paper, a synthetic paper, a plastic film such as an overhead projector sheet (OHP), a paper whose surface is coated such as a coated paper, a special shaped sheet such as an envelope and a cloth.

The image forming apparatus 2 is provided with an intermediary transfer belt 40 and an outer secondary transfer roller 50. The station 10Y, the station 10M, the station 10C and the station 10K form a yellow toner image, a magenta toner image, a cyan toner image and a black toner image on the intermediary transfer belt 40, respectively. Configurations of the station 10Y, the station 10M, the station 10C and the station 10K are common except that toner colors are different. For this reason, a configuration of the station 10Y will be described as an example here, and descriptions of configurations of the other stations which are the station 10M, the station 10C and the station 10K will be omitted.

A photosensitive drum 11 as an image bearing member rotates in a direction R1 in FIG. 1. A charger 12 charges a surface of the photosensitive drum 11 to a uniform surface potential. An exposure device 13 includes a light source which outputs a laser light and forms an electrostatic latent image on the photosensitive drum 11 according to image information by an electrophotographic process which is common knowledge. A developer 14 develops an electrostatic latent image which is formed on the photosensitive drum 11 and forms a toner image by using developer which includes toner. Here, a reversal development method, in which toner is attached to an exposed portion of the electrostatic latent image and developed, is used.

A primary transfer roller 15 is arranged opposing the photosensitive drum 11 via the intermediary transfer belt 40. The primary transfer roller 15 primary transfers the toner image on the photosensitive drum 11 onto the intermediary transfer belt 40 by applying a transfer bias which is controlled to be constant voltage opposite polarity to the toner image in synchronization with the toner image being conveyed to a primary transfer nip portion. The primary transfer roller 15 is consisted of an elastic layer of ion conductive foam rubber and a core metal, and a transfer roller with an outer diameter which is ranged from 15 mm to 20 mm and a resistance value which is ranged from 1×10⁵Ω to 1×10⁸Ω at 23° C., 50% RH environmental measurement and 2 kV application is used.

The intermediary transfer belt 40 is arranged so as to contact the surface of the photosensitive drum 11, and is stretched over a plurality of stretching rollers, a stretching roller 41, a stretching roller 42, a stretching roller 43, a stretching roller 44, a stretching roller 45, a stretching roller 46 and rotates in an R2 direction at a speed which is ranged from 150 mm/sec to 470 mm/sec. In the embodiment, the stretching roller 41 is a tension roller which controls tension of the intermediary transfer belt 40 to be constant, the stretching roller 43 is a driving roller of the intermediary transfer belt 40, and the stretching roller 42 is an inner roller for a secondary transfer.

The outer secondary transfer roller 50 is an outer roller for the secondary transfer roller which nips and conveys a transfer material with the intermediary transfer belt 40. The outer secondary transfer roller 50 is consisted of an elastic layer of ion conductive foam rubber and a core metal, and a transfer roller with an outer diameter which is ranged from 20 mm to 25 mm and a resistance value which is ranged from 1×10⁵Ω to 1×10⁸Ω at 23° C., 50% RH environmental measurement and 2 kV application is used. The stretching roller 42 is consisted of an elastic layer of ion conductive foam rubber and a core metal, and a transfer roller with an outer diameter which is ranged from 20 mm to 22 mm and a resistance value which is ranged from 1×10⁵Ω to 1×10⁸Ω at 23° C., 50% RH environmental measurement and 2 kV application is used.

A belt cleaning device 47 electrostatically collects and cleans a secondary transfer residual toner on the intermediary transfer belt 40. The intermediary transfer belt 40 which has been cleaned is repeatedly used during an image forming and an imaging process.

The sheet conveying portion 20 conveys the sheet S which is accommodated in a sheet cassette 21 to a secondary transfer portion. The sheet conveying portion 20 includes a sheet feeding portion 22 and a registration roller 23. The registration roller 23 supplies the sheet S to the secondary transfer portion in synchronization with the toner image on the intermediary transfer belt 40 being conveyed to the secondary transfer portion. At that time, the transfer bias which is controlled to be constant voltage opposite polarity to the toner image from a high voltage application portion 51 to the outer secondary transfer roller 50. For example, a transfer voltage which is from +1 kV to +7 kV is applied, an electric current which is from +40 μA to +120 μA is applied, and the toner image on the intermediary transfer belt 40 is transferred to the sheet S. The sheet S is supplied to the secondary transfer portion by a pre-secondary-transfer conveying guide 24 in order to improve conveyance accuracy.

The sheet S is conveyed and introduced into a fixing device 53 by a pre-fixing conveying device 52 and enters a heating and pressing fixing process of the toner image. In a center portion of the pre-fixing conveying device 52, a belt member which is from 100 mm to 110 mm in width and from 1 mm to 3 mm in thickness and which is made of rubber material such as EPDM is rotating, and the sheet S is conveyed while the sheet S is placed on the belt member. The belt member includes holes whose diameters are 3 mm to 7 mm, and bearing power of the sheet S is increased and conveying performance is stabilized by sucking from an inside of the belt member. The fixing device 53 fixes an unfixed toner on the sheet S to the sheet S by applying heat and pressure to the sheet S on which the toner image is formed in the image forming portion 10.

The control portion 30 includes CPU, RAM and ROM, and controls each portion in the image forming apparatus 2. The CPU outputs output signals to each electric part in order to operate the electric part at a desired timing and with a required control amount based on detection signals which are input from each sensor and information which is stored in the ROM. Therefore, it is the CPU that actually controls the electrical parts. The ROM and the RAM store information data which is necessary to control each portion, and the CPU reads the information data which is stored in the ROM and writes it to the RAM.

The operation portion 31 is provided with a display screen and selection keys. The operation portion 31 displays information which is output from the control portion 30 on the display screen, and inputs to the control portion 30 when receiving operation instructions from a user by the selection keys. From the operation portion 31, an operation mode, sheet information to be passed, etc. are set by the user.

### [Charge-Eliminating Device]

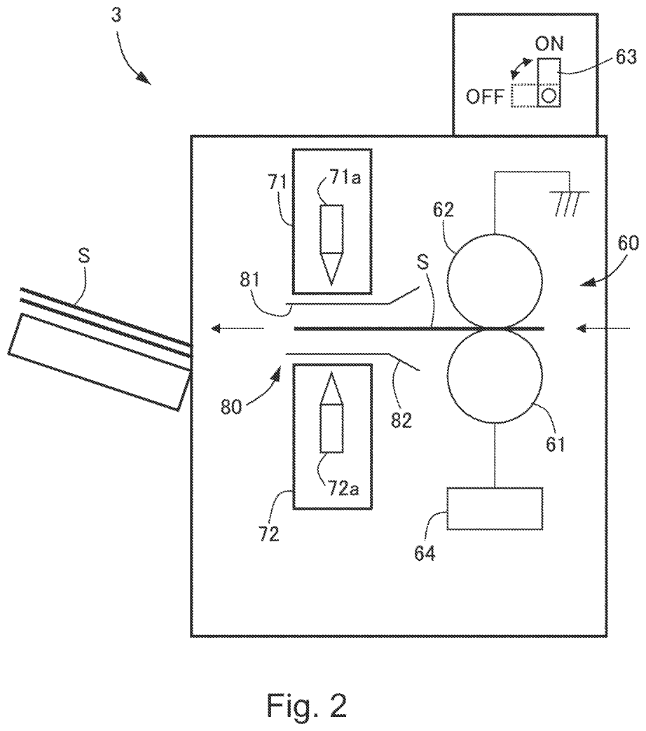

A schematic configuration of the charge-eliminating device 3 according to the embodiment is shown in FIG. 2. The charge-eliminating device 3 is provided on a downstream side of the image forming apparatus 2 with respect to a sheet conveying direction, receives the sheet S in which the image is formed from the image forming apparatus 2 and eliminates charge of the sheet S. The charge-eliminating device 3 includes a charge-eliminating roller pair 60 which is a contact type charge-eliminating unit, and a first ionizer 71 and a second ionizer 72 which are noncontact type charge-eliminating units which are arranged on a downstream side with respect to the sheet conveying direction. The charge-eliminating roller pair 60 also functions as a conveying member which conveys the sheet.

The charge-eliminating roller pair 60 includes a charge-eliminating roller 61 and an opposing roller 62. As the charge-eliminating roller 61, a transfer roller with an outer diameter which is ranged from 20 mm to 25 mm, which includes an elastic layer of ion electrically conductive foamed rubber and a core metal, is used. A resistance value of the charge-eliminating roller 61 is ranged from 1×10⁵Ω to 1×10⁸Ω at 23° C., 50% RH environmental measurement and 2 kV application. As the opposing roller 62, a roller which is made of SUS with an outer diameter which is ranged from 20 mm to 25 mm is used and a charge-eliminating nip portion is formed by arranging opposed to the charge-eliminating roller 61. That is, the charge-eliminating roller pair 60 is arranged on upstream side of the first ionizer 71 and the second ionizer 72 with respect to a recording material conveying direction, and nips and eliminates charge of the sheet S before the sheet S is guided by a conveying guide portion 80 which will be described below. Further, a changeover switch 63 of charge-eliminating voltage is provided, and it is possible for the user to switch between an on state and an off state of voltage which is applied to the charge-eliminating roller 61 by a high voltage power source 64.

Here, in a case of the sheet S with high electrical resistance such as synthetic paper, when an electric charge is charged, a polarity on a front side of the sheet S is opposite to a polarity on a back side of the sheet S. Therefore, even when trying to eliminate charge by irradiating with ions on only one side, the electric charge on an opposite side remains retained since current does not flow and charge-eliminating performance may be greatly reduced. In contrast, it is possible to eliminate charge so that the electric charge on the opposite side of the sheet S releases to a metal plate by arranging the metal plate on the back side of the sheet S by using the corotron type. However, in this case, since it is necessary to contact the metal plate and a sheet surface each other, it may cause conveying failure and conveying flaw due to adhering and sliding of the sheet S. Therefore, in the embodiment, the ionizers are arranged on both the front side and the back side of the sheet S.

Each of the first ionizer 71 and the second ionizer 72 is one of examples of ionizers which eliminate charge of the sheet S which is guided by the conveying guide portion 80, which will be described below, by means of generated ions. The first ionizer 71 is arranged on a first surface side (top surface side) of the sheet S which is conveyed, and the second ionizer 72 is arranged on a second surface side (bottom surface side) which is an opposite side of the first surface side of the sheet S which is conveyed. That is, the first ionizer 71 is one of examples of a first charge-eliminating unit which eliminates charge of the sheet S which is guided by the conveying guide portion 80, in a noncontact manner. The second ionizer 72 is arranged on an opposite side of the first ionizer 71 across the conveying guide portion 80 and is one of examples of a second charge-eliminating unit which eliminates charge of the sheet S which is guided by the conveying guide portion 80, in a noncontact manner. In other words, the first ionizer 71 is arranged on one side of a conveying passage with respect to a sheet thickness direction, and the second ionizer 72 is arranged on the other side of the conveying passage with respect to the sheet thickness direction.

In the embodiment, the first ionizer 71 and the second ionizer 72 are arranged so that they overlap at least a part of them when they are viewed in a thickness direction of the sheet S. That is, it is possible to eliminate charge of the sheet S at the almost same position on the front side and the back side of the sheet S at the same time.

The first ionizer 71 includes a first needle electrode 71a as a needle electrode which is arranged to oppose to the conveying guide portion 80 with respect to the thickness direction of the sheet S (vertical direction) and the first needle electrode 71a generates ions when a high voltage potential is applied. The second ionizer 72 includes a second needle electrode 72a as a needle electrode which is arranged to oppose to the conveying guide portion 80 with respect to the thickness direction of the sheet S (vertical direction) and the second needle electrode 72a generates ions when a high voltage potential is applied. For each of the first ionizer 71 and the second ionizer 72, ionizer bar type IZS40 (manufactured by SMC), for example, is used.

Each of electric outputs of the first ionizer 71 and the second ionizer 72 is set as 30 Hz of an AC waveform. When the frequency is 10 Hz or higher, almost same charge-eliminating effects are obtained, however, when the frequency is lower than 10 Hz, an ion balance on a surface of an objected transfer material is tended to be unstable since unevenness of + and − ion irradiation amount is generated. In the embodiment, the first ionizer 71 and the second ionizer 72 are provided at positions on both the front side and the back side of the sheet S which is conveyed as shown in FIG. 2, so it is possible to emit ions onto the front side and the back side of the sheet S at the same time.

The first ionizer 71 and the second ionizer 72 are arranged at distances of 50 mm above and below in a vertical direction, respectively from the conveying passage of the sheet S and form an ionizer irradiation portion. The first ionizer 71 which is used in the embodiment applies a method of generating charge-eliminating ions by applying high voltage to a leading end of an emitter of the first needle electrode 71a, and distance between adjacent emitters is 60 mm. Therefore, when an object to be performed charge elimination is too close to the first ionizer 71, dispersion of an amount of ion may be occurred and uneven charge elimination may be occurred.

On the other hand, when the object to be performed charge elimination is too far away from the first ionizer 71 (for example, 100 mm), charge-eliminating performance is rapidly degraded. Therefore, the distance which is described above is set to be as close to the object as possible within a range which does not cause uneven charge elimination. Incidentally, the same applies to the second ionizer 72, so description will be omitted. Incidentally, in the embodiment, a case in which an ionizer which applies a needle electrode is used is described, however, it is not limited to this and a corotron type charge-eliminating unit which applies a wire electrode may also be used. In a case that an ion generating source is a wire shaped corotron type, etc., it is expected to improve the charge-eliminating performance when it is arranged closer to the sheet S within a range that it does not affect conveyance of the sheet S.

Between the first ionizer 71 and the second ionizer 72, the conveying guide portion 80, which is one of examples of a guide portion which guides upper and lower surfaces of the sheet S which is conveyed, is provided. The conveying guide portion 80 forms a conveying passage through which the sheets are conveyed. The conveying guide portion 80 includes a first guide member 81 which guides the upper surface side of the sheet S which is conveyed, and a second guide member 82 which is arranged opposing the first guide member 81 and guides the lower surface side of the sheet S which is an opposite side of the upper surface side of the sheet S which is conveyed. The first guide member 81 is one of examples of a first guide member, and the second guide member 82 is one of examples of a second guide member. Therefore, the first ionizer 71 is arranged opposing the first guide member 81 in the thickness direction of the sheet S, and the second ionizer 72 is arranged opposing the second guide member 82 in the thickness direction of the sheet S.

Here, in a case that the conveying guide portion 80 between the ionizer and the sheet S is a conductive material such as metal, the charge-eliminating performance is significantly degraded since ions are absorbed by electric charge (electrostatic induction) of an opposite polarity of ions which is induced on a metal surface. Therefore, in the embodiment, the conveying guide portion 80 is made of insulating material.

In the embodiment, the conveying guide portion 80 applies resin in which PC (polycarbonate) and ABS (acrylonitrile-butadiene-styrene) are synthesized. Volume resistivity of the conveying guide portion 80 is 1×10¹⁴ Ω-cm. Incidentally, material of the conveying guide portion 80 is not limited to this, and it is possible to apply any appropriate insulating materials, such as PET (polyethylene terephthalate) and acrylic resin, for example. Further, in the embodiment, the conveying guide portion 80 is made of an insulating material, however, it is not limited to this, for example, an entire surface of conductive material may be made of insulating material. For example, an insulating sheet may be attached to an entire surface of a member which is made of metal. That is, at least the surface of the conveying guide portion 80 is made of insulating material. Further, in the embodiment, a case in which the volume resistivity of the conveying guide portion 80 is 1×10¹⁴ Ω-cm is described, however, it is not limited to this case. The volume resistivity of the conveying guide portion 80 may be, for example, 1×10⁶ Ω-cm or higher.

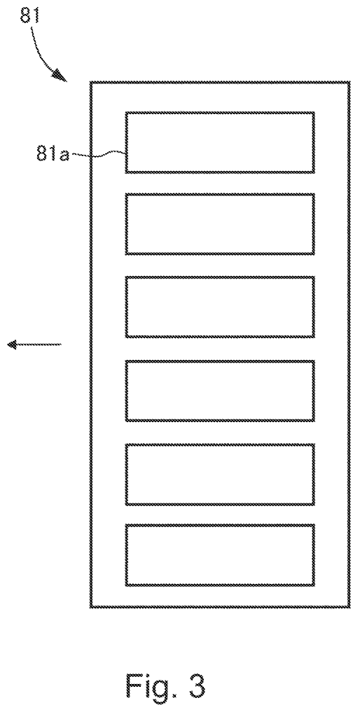

As shown in FIG. 3, a through hole 81a is formed in the first guide member 81. The through hole 81a penetrates the first guide member 81 in the thickness direction of the sheet S. The through hole 81a allows ions which are generated from the first ionizer 71 to pass toward the sheet S so that the ions are not physically shielded by the first guide member 81. The larger the through hole 81a is, the more ions are able to pass through it, however, conveyance accuracy of the sheet S is degraded, so the size of the through hole 81a may be appropriate. The size of the through holes 81a is, for example, approximately 5 cm per side and the plurality of through holes are provided side by side in the sheet width direction so that they can be provided over a wide area in accordance with a length of the sheet S which is conveyed in the width direction. For example, when the maximum size of the sheet S which is conveyed is A3 size, the plurality of through holes 81a is intermittently provided in a range of approximately 300 mm in the width direction in accordance with the sheet width length of 297 mm. Further, not shown in the figure, similarly a through hole is formed in the second guide member 82.

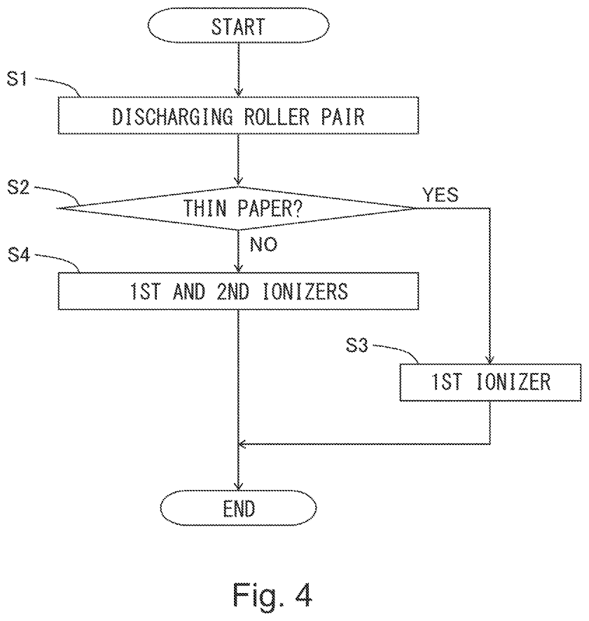

Next, one of examples of procedure when it is performed charge elimination will be described according to a flowchart which is shown in FIG. 4. When the control portion 30 starts charge-eliminating, firstly, electrification charge is roughly eliminated from the sheet S which is conveyed from the image forming apparatus 2 at the charge-eliminating nip portion which is nipped by the charge-eliminating roller 61 and the opposing roller 62 (STEP S1). The high voltage potential which is applied from the high voltage power source 64 to the charge-eliminating roller 61 is applied with an opposite polarity to the voltage which is applied to the outer secondary transfer roller 50. Specifically, voltage which is ranged from −1 kV to −6 kV is applied.

The control portion 30 determines whether the sheet S to be objected is a thin paper or not (STEP S2). In a case that it is determined that it is a thin paper (YES in step S2), it is possible to be performed charge elimination by using only the first ionizer 71, so it is performed charge elimination by only the first ionizer 71 (STEP S3). In a case that it is determined that it is not a thin paper (NO in STEP S2), such as synthetic paper, it is not possible to be performed charge elimination by using only the first ionizer 71, so both the first ionizer 71 and the second ionizer 72 are used at the same time to eliminate charge (STEP S4). In this way, any charge which could not be fully performed charge elimination at the charge-eliminating nip portion of the charge-eliminating roller pair 60 is removed and the sheet S is discharged to the outside from the charge-eliminating device 3. That is, in a case that the sheet S is a synthetic paper which is a first material, it is performed charge elimination by both the first ionizer 71 and the second ionizer 72, and in a case that the sheet S is a thin paper which is a second material which is different from a synthetic paper, it is performed charge elimination by only the first ionizer 71. Incidentally, since the flowchart which is shown in FIG. 4 is one of examples, for example, both the first ionizer 71 and the second ionizer 72 may be used at the same time to eliminate charge of all kinds of the sheets S.

As described above, in the charge-eliminating device 3 according to the embodiment, the first ionizer 71 is arranged on the upper side of the sheet S and the second ionizer 72 is arranged on the lower side of the sheet S. Thus, in a case that the sheet S in which electric resistance is high such as a synthetic paper, even when the charge on the front side is opposite polarity to the charge on the back side at the time of charging, it is possible to eliminate charge of both sides of the sheet S respectively by irradiating with ions on both sides of the sheet S, and it is possible to improve the charge-eliminating performance.

Further, the charge-eliminating device 3 according to the embodiment, it is possible to switch between charge-eliminating by both the first ionizer 71 and the second ionizer 72 and charge-eliminating only by the first ionizer 71, depending on a paper type. Therefore, it is possible to reduce consumption of the electrode by stopping use of the second ionizer 72 in a case that it is possible to eliminate charge by only the first ionizer 71, such as a thin paper which is low resistance, for example.

By the way, in a case that the corotron type is applied as a noncontact type charge-eliminating unit, since AC high voltage is required, the device may become larger due to size increase of a high voltage board and securing of creepage distance. On the other hand, in the charge-eliminating device 3 according to the embodiment, an ionizer is applied as a noncontact charge-eliminating unit. Therefore, it is possible to achieve miniaturization of the charge-eliminating device 3 compared to the corotron type.

Incidentally, in the embodiment which is described above, a case that the first ionizer 71 is arranged on the upper side of the sheet S and the second ionizer 72 is arranged on the lower side of the sheet S is described, however, the present invention is not limited to this. For example, even when the second ionizer 72 is not provided, it is possible to achieve a certain effect. Further, a case in which the first guide member 81 is arranged on the upper side of the sheet S is described, however, the present invention is not limited to this, and it is not necessary to arrange the first guide member 81 when conveying the sheet S does not have any problems.

Further, in the embodiment which is described above, for example, a case that the first ionizer 71 includes the first needle electrode 71a in which a leading edge is thinner is described, however, the present invention is not limited to needle shape as an electrode shape. For example, a wire shaped electrode in which a leading edge which is directed to the sheet S is not thinner, a wire electrode which is applied in the corotron type, etc. may be applied. That is, the ionizer which applies the needle electrode is exemplified as a noncontact ion generating means, when it is a configuration in which it is possible to emit positive ions and negative ions from each of ion generating means, it is possible to expect the same effect even when a corotron type charger or a scorotron charger is used. Furthermore, as the first charge-eliminating unit and the second charge-eliminating unit which eliminate charge in the noncontact manner, the present invention is not limited to the ion generating means such as an ionizer, however, for example, ultraviolet light irradiating means may be used.

Further, in the embodiment which is described above, a case in which the charge-eliminating device 3 is applied as a device which is independent of the image forming apparatus 2 is described, however, the present invention is not limited to this. For example, the charge-eliminating device 3 may be incorporated in the image forming apparatus 2 as a part of the image forming apparatus 2.

In the embodiment, an example of the image forming apparatus 2 of an electrophotographic method which applies an electric charge to the sheet S to form toner on the surface of the sheet S is exemplified, however, the present invention is not limited to this. That is, when it is configured so that an image is formed on the sheet S and a phenomenon in which the sheet S is electrically charged is occurred, it is possible to apply to, for example, an inkjet type, etc. Further, a configuration according to the embodiment is also effective in a case of removing charges after a post-process after image forming of the sheet S.

It is possible to achieve a higher effect when the upper ion generating portion and the lower ion generating portion emit ions of opposite polarities on the front side and the back side at the same time, respectively, however, it is not necessary to synchronize each of high voltage waveforms of the upper ion generating portion and the lower ion generating portion by setting the frequency of the high voltage AC to 10 Hz or higher, for example. Further, it is possible to achieve effects of charging and discharging the surface of the transfer material even when DC waveforms of the opposite polarities on the front side and the back side are emitted, however, an effect of converging the potential to 0 kV, which is an advantage of the ion generating portion in the embodiment, become ineffective.

### First Embodiment

The charge-eliminating device 3 according to the embodiment which is described above is used to eliminate charge of the sheet S. The conditions are as follows: the first ionizer 71 and the second ionizer 72 are used, the charge-eliminating roller 61 is used, and the conveying speed at the ionizers is 470 mm/s.

As a verification method of charge-eliminating effect, a surface potential of the sheet S which is discharged from the charge-eliminating device 3 is measured. Specifically, it is measured in a low humidity environment (temperature is 23° C., relative humidity is 5%) by using imagePRESS C910 (manufactured by Canon). As for the measurement, after a synthetic paper YPI250 (manufactured by Yupo) in which an image is formed is performed charge elimination by the charge-eliminating device 3, the sheet S which is discharged is placed on a grounded sheet metal and surface potential is measured by SK-H050 (manufactured by KEYENCE). Furthermore, evaluation results are recorded as “o” in a case that the surface potential which is measured is less than 0.5 kV and recorded as “x” in a case that the surface potential which is measured is 0.5 kV or higher. As for the reason of the evaluation results, in a case that the surface potential is 0.5 kV or higher, since the surface potential of the back surface is an opposite polarity of the surface potential of the front surface when the high resistance transfer material is used, an attractive force is generated between the front surface and the back surface. Therefore, a plurality of sheets of paper electrostatically attract and stick each other and this may interfere with user handling.

### Second Embodiment

The charge-eliminating device 3 according to the embodiment which is described above is used to eliminate charge of the sheet S. The conditions are as follows: the first ionizer 71 and the second ionizer 72 are used, the charge-eliminating roller 61 is not used (the changeover switch 63 is turned off), and the conveying speed at the ionizers is 150 mm/s.

### Comparison Example 1

The charge-eliminating device 3 according to the embodiment which is described above is used to eliminate charge of the sheet S. The conditions are as follows: the first ionizer 71 and the second ionizer 72 are not used, the charge-eliminating roller 61 is used, and the conveying speed at the ionizers is 470 mm/s.

### Comparison Example 2

The charge-eliminating device 3 according to the embodiment which is described above is used to eliminate charge of the sheet S. The conditions are as follows: only the first ionizer 71 is used, the charge-eliminating roller 61 is used, and the conveying speed at the ionizers is 470 mm/s.

### Comparison Example 3

The charge-eliminating device 3 according to the embodiment which is described above is used to eliminate charge of the sheet S. The conditions are as follows: only the first ionizer 71 is used, the charge-eliminating roller 61 is not used (the changeover switch 63 is turned off), and the conveying speed at the ionizers is 150 mm/s.

### Comparison Example 4

The charge-eliminating device 3 according to the embodiment which is described above is used to eliminate charge of the sheet S. The conditions are as follows: the first ionizer 71 and the second ionizer 72 are not used, the charge-eliminating roller 61 is not used (the changeover switch 63 is turned off), and the conveying speed at the ionizers is 150 mm/s.

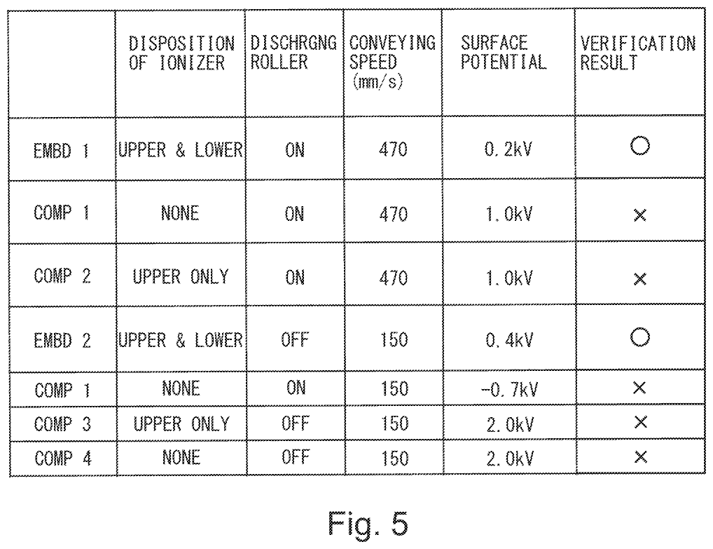

The verification results are shown in FIG. 5. First, the first embodiment, the comparison example 1, and the comparison example 2, which use the charge-eliminating roller 61, will be verified. A good result is obtained for the first embodiment, while the comparison example 1 and the comparison example 2 showed a decrease in the surface potential at the charge-eliminating roller 61. However, considering a value in the comparative example 1, almost no charge-eliminating effect of the surface potential by only the first ionizer 71 in the comparative example 2 is seen.

Next, the second embodiment, the comparison example 3, and the comparison example 4, which does not use the charge-eliminating roller 61, will be verified. This verification shows an example that it is possible to eliminate charge of the sheet S when the conveying speed of the sheet S is low and sufficient ion irradiation time is ensured even in a configuration without the charge-eliminating roller 61 which is contact type. As shown in FIG. 5, a good result is obtained in the second embodiment, while considering the value in the comparative example 4, almost no charge-eliminating effect of the surface potential by only the first ionizer 71 in the comparative example 3 is seen.

Further, the result of the comparative example 1 in which it is configured of only the charge-eliminating roller 61 is shown as a reference, however, in a case that charge which is applied is insufficient or excessive, problems which will be described below are generated. It is possible to make the surface potential of the sheet S which is discharged from the charge-eliminating device 3 closer to 0 kV by varying the conveying speed and voltage which is applied to the charge-eliminating roller 61. However, prior verification by a user is required, and the value may not be stable depending on temperature and humidity of surrounding environment. Therefore, in the disclosure, it is determined that it is effective to arrange ionizers, which are capable of making the surface potential of the sheet S closer to 0 kV without depending on the conditions, downstream of the charge-eliminating roller 61. As described above, by the disclosure, it is confirmed that it is possible to achieve the charge-eliminating effect which is stable without depending on the conditions for the sheet S which is charged.

### DESCRIPTION OF EFFECT

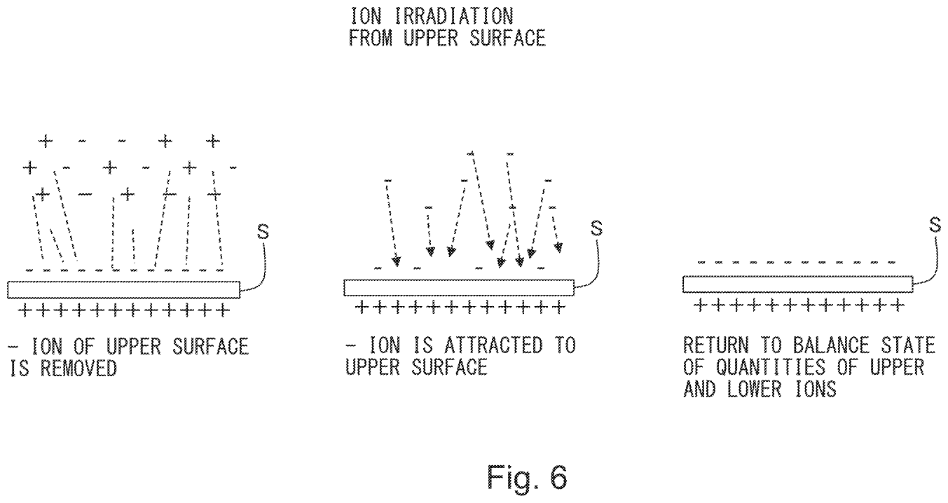

By the results from the verification, it shows that charge-eliminating effect on the high resistance transfer material is small in a case of ion irradiation on only one side of the sheet S. The present inventors will describe this phenomenon with a following simplified model. As shown in FIG. 6, the upper surface and the lower surface of the sheet S are in a state in which the charges of each of opposite polarities are balanced, and even when ion irradiation from one side in the comparative example removes the charges on the irradiation surface, a quantity of charges on the opposite surface remains almost unchanged. Therefore, in a case of the sheet S which is high resistance such as a synthetic paper, since it is not possible to transfer the charges between the front surface and the back surface, the charges on the emitted surface returns to its original quantity to balance the quantity of the charges on the opposite surface in which the quantity of the charges is large.

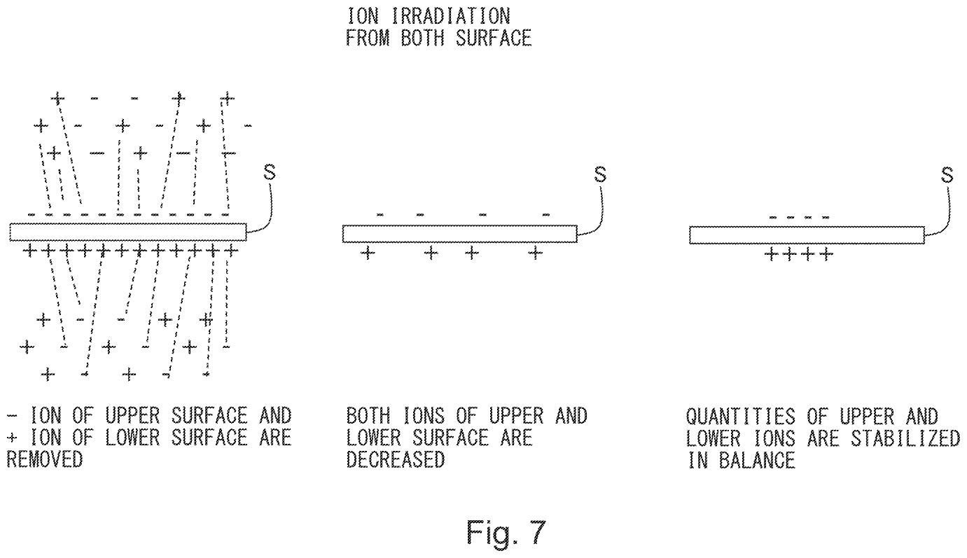

On the other hand, as shown in FIG. 7, the charges on both of the surfaces is removed by irradiating with the ions from both of the surfaces at the same time. Therefore, when the quantity of the charges on either surface is reduced, it is possible to balance in a state that absolute value of the quantity of the surface charges is low.

As a verification of these simplified models, it is possible to achieve the same effect as the state in which the ions are emitted from both surfaces by setting a state that the opposite surface contacts the metal plate which is mounted, even when the ion irradiation is only from the top surface. It is thought that the quantity of the charges is decreased equally on the front surface and the back surface at the same time by releasing the opposite polarity charges which is the same quantities with the charges which is removed on the irradiation surface to the metal plate which is on the opposite surface.

According to the disclosure, it is possible to improve the charge-eliminating performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-011718 filed on Jan. 30, 2023, which is hereby incorporated by reference herein in its entirety.

What is claimed is:

1. A charge-eliminating device for eliminating charge of a sheet on which toner is fixed by an image forming apparatus, the charge-eliminating device comprising:
a conveying guide configured to form a conveyance passage through which the sheet conveyed from the image forming apparatus is conveyed;
a first charge-eliminating unit disposed on one side of the conveyance passage in a thickness direction of the sheet and configured to eliminate charge of the sheet in a non-contact state with the sheet; and
a second charge-eliminating unit disposed on the other side of the conveyance passage in the thickness direction and configured to eliminate charge of the sheet in the non-contact state with the sheet.

2. A charge-eliminating device according to claim 1, wherein as viewed in the thickness direction, the first charge-eliminating unit and the second charge-eliminating unit are disposed so that at least a part thereof is overlapped with each other.

3. A charge-eliminating device according to claim 1, wherein in a case in which the sheet is a first material, both of the first charge-eliminating unit and the second charge-eliminating unit eliminate charge of the sheet, and in a case in which the sheet is a second material different from the first material, the first charge-eliminating unit eliminates charge of the sheet but the second charge-eliminating unit does not eliminate charge of the sheet.

4. A charge-eliminating device according to claim 1, wherein the first charge-eliminating unit is a first ionizer including a first needle-like electrode for generating an ion by a voltage being applied, and
wherein the second charge-eliminating unit is a second ionizer including a second needle-like electrode for generating an ion by a voltage being applied.

5. A charge-eliminating device according to claim 1, wherein the conveying guide includes a first guide member configured to guide a first surface of the sheet conveyed, and a second guide member disposed opposite to the first guide member and configured to guide a second surface of the sheet conveyed,
wherein the first charge-eliminating unit is disposed opposite to the first guide member with respect to the thickness direction of the sheet, and
wherein the second charge-eliminating unit is disposed opposite to the second guide member with respect to the thickness direction of the sheet.

6. A charge-eliminating device according to claim 1, further comprising a charge-eliminating roller pair disposed upstream of the first charge-eliminating unit and the second charge-eliminating unit with respect to a sheet conveying direction and configured to nip and eliminate charge of the sheet.

7. An image forming system comprising:
an image forming apparatus configured to form an image by toner being fixed to a sheet; and
a charge-eliminating device configured to eliminate charge of the sheet on which the toner is fixed by the image forming apparatus,
wherein the charge-eliminating device includes
a conveying guide configured to form a conveyance passage through which the sheet conveyed from the image forming apparatus is conveyed,
a first charge-eliminating unit disposed on one side of the conveyance passage in a thickness direction of the sheet and configured to eliminate charge of the sheet in a non-contact state with the sheet, and
a second charge-eliminating unit disposed on the other side of the conveyance passage in the thickness direction and configured to eliminate charge of the sheet in the non-contact state with the sheet.
